(19) United States
(12) Patent Application Publication
(10) Pub. No.: US 2014/0184354 A1
(43) Pub. Date: Jul. 3, 2014

(54) FILTER APPARATUS, BASE STATION SYSTEM, AND METHOD FOR FREQUENCY CHANNEL SWITCHING

(71) Applicant: Huawei Technologies Co., Ltd., Shenzhen (CN)

(72) Inventors: Jing SHI, Shanghai (CN); Qun FANG, Shanghai (CN)

(73) Assignee: Huawei Technologies Co., Ltd., Shenzhen (CN)

(21) Appl. No.: 14/196,580

(22) Filed: Mar. 4, 2014

Related U.S. Application Data
(63) Continuation of application No. PCT/CN2012/079704, filed on Aug. 6, 2012.

(30) Foreign Application Priority Data
Nov. 15, 2011 (CN) 201110361113.0

(51) Int. Cl. H01P 1/213; H01P 1/20

(52) U.S. Cl. CPC H01P 1/207
USPC 333/134; 333/202; 333/3

(57) ABSTRACT

Embodiments of the present invention disclose a filter apparatus, a base station system, and a method for frequency channel switching. In application of technical solutions provided by the embodiments of the present invention, the grounding probe connected to the electrical ground contacts or approaches the resonator to short-circuit or disturb a resonant cavity that includes the resonator, so as to reject output of an input signal of the filter apparatus and finally achieve an effect of closing the filter apparatus; when the filter apparatus is used in combination with multiple other filter apparatuses, and when the filter apparatus is closed, spurious signals of the other filter apparatuses are not propagated to an antenna port through the filter apparatus.

### CROSS-REFERENCE TO RELATED APPLICATIONS

This application is a continuation of International Application No. PCT/CN2012/079704, filed on Aug. 6, 2012, which claims priority to Chinese Patent Application No. 201110361113.0, filed on Nov. 15, 2011, both of which are hereby incorporated by reference in their entireties.

### FIELD OF TECHNOLOGY

Embodiments of the present invention relate to the communications field, and in particular, to a filter apparatus, a base station system, and a method for frequency channel switching.

### BACKGROUND

In a base station system, a filter may be a part of a radio frequency unit of the base station system. The filter may allow wanted signals to pass and have a rejecting function on interference signals to some extent. The filter usually contains multiple resonant cavities. A resonator in each resonant cavity is a frequency-selective structural unit. The resonant cavity causes small signal loss for a signal of a particular frequency, and causes large signal loss for a signal of a frequency other than the particular frequency. One resonant cavity and one resonator make up one filter unit of a filter. Usually, a combination of multiple such filter units is used, so that the entire filter has a filter feature.

In the base station system, demands for miniaturization and low cost require that system components should be shared, which brings about many new problems about implementation of system indices. At present, in a composition system having a wideband power amplifier, a dual-channel filter and a wideband antenna, in a scenario where working with dual-frequency channels falls back to working with a single-frequency channel, an out-of-band spurious signal of an emitted signal of the single-frequency channel may be caused to be propagated to an antenna port through another channel in a case of no rejection.

### SUMMARY

Embodiments of the present invention provide a filter apparatus, a base station system, and a method for frequency channel switching.

In one aspect, an embodiment of the present invention provides a filter apparatus, including at least one resonant cavity, where each of the at least one resonant cavity includes one resonator, and the filter apparatus further includes:
at least one grounding probe, where the at least one grounding probe is configured in the filter apparatus, the at least one grounding probe is a conductor connected to an electrical ground, and when any one of the at least one grounding probe moves into any one of the at least one resonant cavity to contact or approach a resonator, the filter apparatus is closed.

According to the technical solution provided by the embodiment of the present invention, the grounding probe connected to the electrical ground contacts or approaches the resonator to short-circuit or disturb the resonant cavity that contains the resonator, so as to reject the output of signals input to the filter apparatus, and finally achieve an effect of closing the filter apparatus. When the filter apparatus is used in combination with multiple other filter apparatuses, and when the filter apparatus is closed, spurious signals of the other filter apparatuses are not propagated to an antenna port through the filter apparatus.

In another aspect, an embodiment of the present invention provides a base station system, including a main unit and at least one radio frequency unit, where the main unit and the at least one radio frequency unit are connected through an optical fiber, and the radio frequency unit further includes: a multi-channel filter, where the multi-channel filter includes at least two filter apparatuses, and the at least two filter apparatuses are connected in parallel.

According to the technical solution provided by the embodiment of the present invention, the multi-channel filter of the base station system closes or opens any combination of the at least two filter apparatuses, and a spurious signal of an input signal of another filter apparatus cannot pass a filter apparatus closed by the multi-channel filter, so that frequency channel switching of the base station system may be implemented.

In another aspect, a method for frequency channel switching is provided, where in the method, any combination of at least two filter apparatuses of the preceding base station system is closed or opened, so as to implement frequency channel switching.

According to the technical solution provided by the embodiment of the present invention, in a radio frequency unit of the base station system, it is configured that a multi-channel filter closes any combination of at least two filter apparatuses, and a spurious signal of another filter apparatus cannot pass a filter apparatus closed by the multi-channel filter, so that frequency channel switching of the base station system is implemented.

### BRIEF DESCRIPTION OF THE DRAWINGS

FIG. 1(A) is a schematic structural diagram of a base station system;

FIG. 1(B) is a schematic diagram of a part of a radio frequency unit in a base station system;

FIG. 2 is a schematic structural diagram of a filter apparatus according to a first embodiment of the present invention;

FIG. 3(A) to FIG. 3(E) are schematic structural diagrams of a filter apparatus according to a second embodiment of the present invention;

FIG. 4(A) and FIG. 4(B) are schematic structural diagrams of a filter apparatus according to a third embodiment of the present invention;

FIG. 4(C) to FIG. 4(E) are schematic connection diagrams of resonant cavities in the filter apparatus according to the third embodiment of the present invention;

FIG. 5(A) is a schematic diagram of a base station system according to a fourth embodiment of the present invention;

FIG. 5(B) is a schematic structural diagram of a multi-channel filter in the base station system according to the fourth embodiment of the present invention;

FIG. 5(C) is a schematic structural diagram of a multi-channel filter in the base station system according to the fourth embodiment of the present invention;

FIG. 6 is a diagram showing an effect of turning off a channel of a dual-channel filter in the base station system according to the fourth embodiment of the present invention;

FIG. 7 is a schematic diagram of a method for frequency channel switching according to a fifth embodiment of the present invention; and

FIG. 8(A) to FIG. 8(C) are schematic diagrams of a method for frequency channel switching according to a sixth embodiment of the present invention.

### DETAILED DESCRIPTION

Technical solutions in embodiments of the present invention are described clearly and completely in following with reference to accompanying drawings in the embodiments of the present invention. Apparently, the described embodiments are only part rather than all of the embodiments of the present invention. For example, the present invention is described based on distributed base station architecture, but the present invention is not limited to base station system architecture described in the embodiments. According to the present invention, a radio frequency unit and a main unit are connected through an optical fiber, but the present invention is not limited thereto. The radio frequency unit and the main unit may also be connected through another transmission medium.

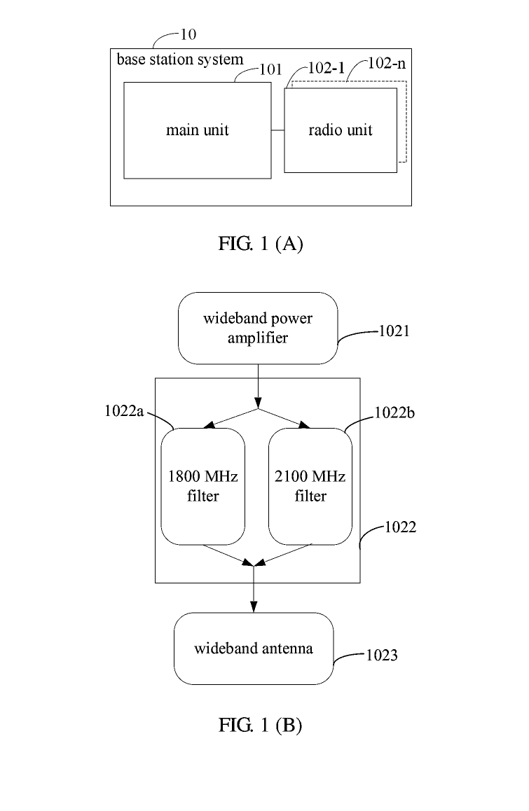

To clarify the inventive concept of the present invention and help those skilled in the art understand the objectives and technical solutions of the present invention more clearly, the following describes system architecture and requirements. FIG. 1(A) is a schematic structural diagram of a base station system according to an embodiment of the present invention. The base station system 10 includes a main unit 101, and at least one radio frequency unit (for example, radio frequency units 102-1 to 102-n, where n is the number of actually used radio frequency units). The main unit 101 is configured to process a baseband signal; the at least one radio frequency unit is configured to emit, in a form of a radio frequency signal, the signal processed by the main unit 101. FIG. 1(B) is a schematic framework diagram showing requirements of the preceding base station system. A combination of a wideband power amplifier 1021, a dual-channel filter 1022, and a wideband antenna 1023 is used as a part of the radio frequency unit of the base station system shown in FIG. 1(A). A filter 1022a with a center frequency of 1800 MHz and a filter 1022b with a center frequency of 2100 MHz make up the dual-channel filter 1022. The filter 1022a with the center frequency of 1800 MHz and the filter 1022b with the center frequency of 2100 MHz are each made up of at least one resonant cavity and one resonator contained in the at least one resonant cavity. The filter 1022a with the center frequency of 1800 MHz and the filter 1022b with the center frequency of 2100 MHz correspond to one frequency channel each. The wideband power amplifier 1021 sends a radio frequency signal to the dual-channel filter 1022; the dual-channel filter 1022 filters the radio frequency signal, and then the radio frequency signal is emitted by the wideband antenna 1023 to propagation space.

Currently, that the dual-channel filter 1022 falls back from a dual-frequency working mode to a single-frequency working mode may cause that an out-of-band spurious signal of an emitted signal passing through the dual-channel filter 1022 is propagated to an antenna port through another channel in a case of no rejection. The dual-frequency working mode means that the filter 1022a with the center frequency of 1800 MHz and the filter 1022b with the center frequency of 2100 MHz in the dual-channel filter 1022 work normally; when an input signal of the dual-channel filter 1022 contains a sub-signal with the center frequency of 1800 MHz and a sub-signal with the center frequency of 2100 MHz, the two sub-signals can pass through the preceding two filters (1022a and 1022b) respectively. Likewise, a concept of a multi-frequency working mode can be obtained, that is, multiple filters of different bands work normally, and signals of the bands, which correspond to the multiple filters of different bands respectively, pass through the multiple filters of different bands respectively. The single-frequency working mode means that the filter 1022a with the center frequency of 1800 MHz and the filter 1022b with the center frequency of 2100 MHz in the dual-channel filter 1022 work normally, and a sub-signal that is in the input signal of the dual-channel filter 1022 and can pass through the dual-channel filter 1022 is only the sub-signal with the center frequency of 1800 MHz or is only the sub-signal with the center frequency of 2100 MHz. For example, when the sub-signal that is in the input signal of the dual-channel filter 1022 and can pass through the dual-channel filter 1022 is only the sub-signal with the center frequency of 1800 MHz, due to an impact of noise, this sub-signal may include a spurious signal of 2100 MHz, and the spurious signal may be transmitted to the antenna port through the filter 1022b with the center frequency of 2100 MHz in a case of no rejection.

If a filter that the spurious signal may possibly pass through can be closed in a scenario where the dual-frequency working mode falls back to the single-frequency working mode, it may be avoided that the spurious signal is transmitted to the antenna port. In addition, a certain match condition needs to be satisfied when the filter 1022a with the center frequency of 1800 MHz and the filter 1022b with the center frequency of 2100 MHz are combined into the dual-channel filter 1022, but the match condition may be damaged after one of the two filters (1022a and 1022b) is closed, which imposes a certain impact on normal work of the filter that needs to be used normally. The embodiments of the present invention are illustrated with reference to such technical problem.

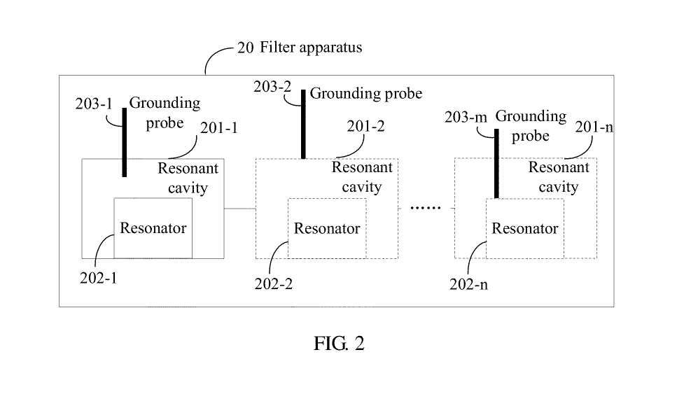

As shown in FIG. 2, a first embodiment of the present invention provides a filter apparatus 20, where the filter apparatus includes: at least one resonant cavity, where each of the at least one resonant cavity contains one resonator, and the filter apparatus 20 further includes:
at least one grounding probe, where the at least one grounding probe is configured in the filter apparatus 20, the at least one grounding probe is a conductor connected to an electrical ground, and when any one of the at least one grounding probe moves into any one of the at least one resonant cavity to contact or approach a resonator, the filter apparatus 20 is closed.

In the embodiment of the present invention, the at least one resonant cavity is resonant cavities 201-1 to 201-n shown in FIG. 2, where n is the number of actually used resonant cavities. The at least one resonator is the resonators 202-1 to 202-n shown in FIG. 2, where n is the number of actually used resonant cavities. One resonant cavity (for example, a resonant cavity 201-1) and one resonator (for example, a resonator 202-1) contained in the resonant cavity make up one unit of the filter apparatus 20, where the unit has a filtering function. After being configured according to system performance indices, the unit may selectively allow a signal of a particular frequency to pass, but impede or prevent a signal that is not of the particular frequency. Multiple such units will increase the extent of impeding or preventing the signal that is not of the particular frequency.

In the first embodiment of the present invention, the electrical ground, that is, the ground, is an object with very low resistance and very large capacitance; it has capabilities of absorbing infinite electric charges; the electrical ground can still keep its electric potential unchanged after absorbing a great number of electric charges. The at least one grounding probe may be grounding probes 203-1 to 203-m shown in FIG. 2, where m is the number of actually used grounding probes, and the number m of actually used grounding probes is not necessarily equal to the number n of actually used resonant cavities. One filter apparatus corresponds to one frequency channel, and a signal of a nominal band of the filter apparatus may pass through the filter apparatus. When the grounding probe connected to the electrical ground, for example, a grounding probe 203-1, moves into a resonant cavity (for example, the resonant cavity 201-1) and starts to approach a resonator 202-1 in a resonant cavity 201-1, the resonant cavity 201-1 starts to be disturbed, that is, a signal of a nominal band of a filter starts to be impeded. In this case, in addition to impeding or preventing a signal of a non-nominal working band of the filter apparatus, the filter apparatus 20 also starts to reject passing of the signal of the nominal working band of the filter apparatus. When an extent to which the grounding probe 203-1 approaches the resonator 202-1, and an extent to which the signal of the nominal working band of the filter apparatus is rejected reach an index set by the system, power of an output signal of the filter apparatus is small to an ignorable extent, and it may be deemed that the filter apparatus is closed. Alternatively, when the grounding probe 203-1 approaches the resonator 202-1 to the greatest extent, that is, the grounding probe 203-1 contacts the resonator 202-1, the resonant cavity is short-circuited. In this case, the filter apparatus 20 impedes the signal of the nominal working band of the filter apparatus 20 to the greatest extent.

Further, when multiple grounding probes are used to short-circuit or disturb multiple resonant cavities at the same time, an extent to which the filter apparatus 20 impedes the signal of the nominal working band of the filter apparatus is increased. When the impeding extent satisfies an index initially set by the system, the output signal of the filter apparatus 20 is small to an ignorable extent, and it may be deemed that the filter apparatus 20 is closed, that is, it is deemed that the signal of the nominal working band of the filter apparatus 20 also cannot pass through the filter apparatus 20. When the grounding probe leaves the at least one resonant cavity, or the grounding probe approaches the resonator in the resonant cavity to an extent that is insufficient to reject the signal of the nominal working band of the filter apparatus so that output of the signal cannot be ignored, the filter apparatus is opened.

The concept described in the first embodiment of the present invention, for example, the resonant cavity, resonator, electrical ground, and process of closing or opening the filter apparatus, unless otherwise specified in the following, represents the same meaning.

According to the technical solution provided by the first embodiment of the present invention, the grounding probe connected to the electrical ground contacts or approaches the resonator to short-circuit or disturb the resonant cavity that includes the resonator, so as to reject output of the input signal of the filter apparatus and finally achieve an effect of closing the filter apparatus. When the filter apparatus is used in combination with multiple other filter apparatuses, and when the filter apparatus is closed, spurious signals of the other filter apparatuses are not propagated to an antenna port through the filter apparatus.

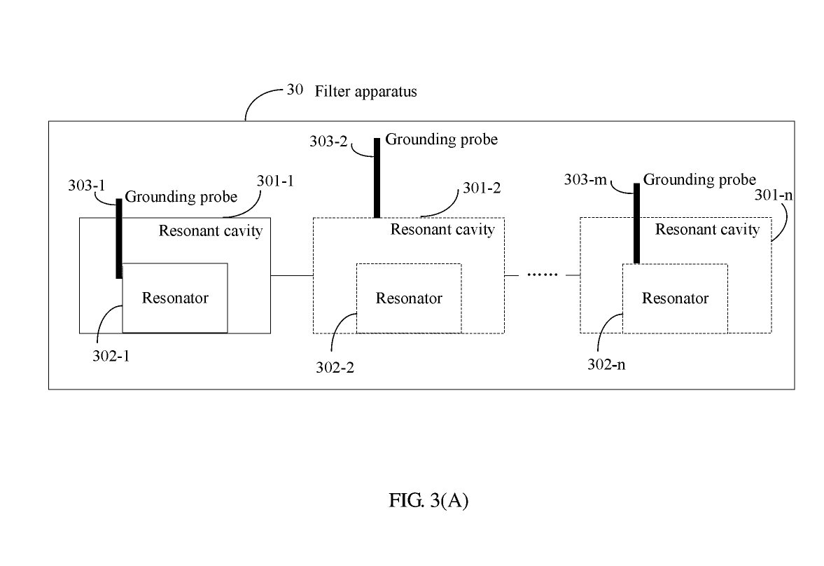

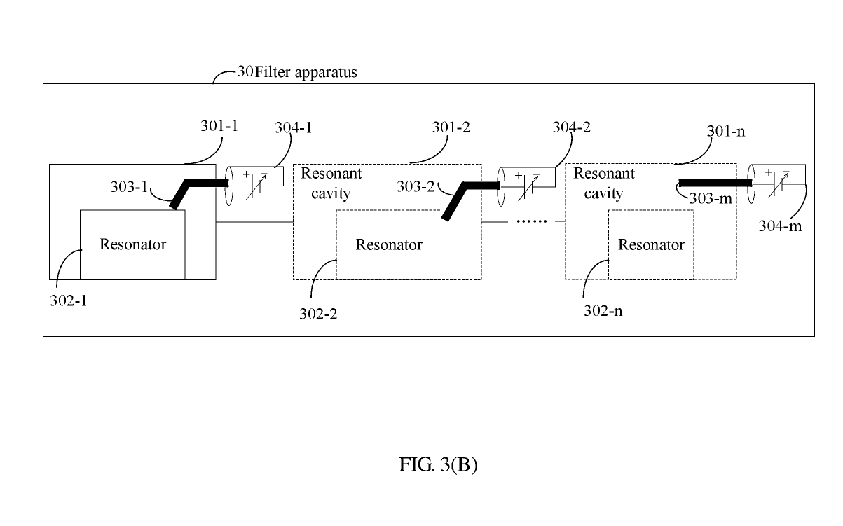

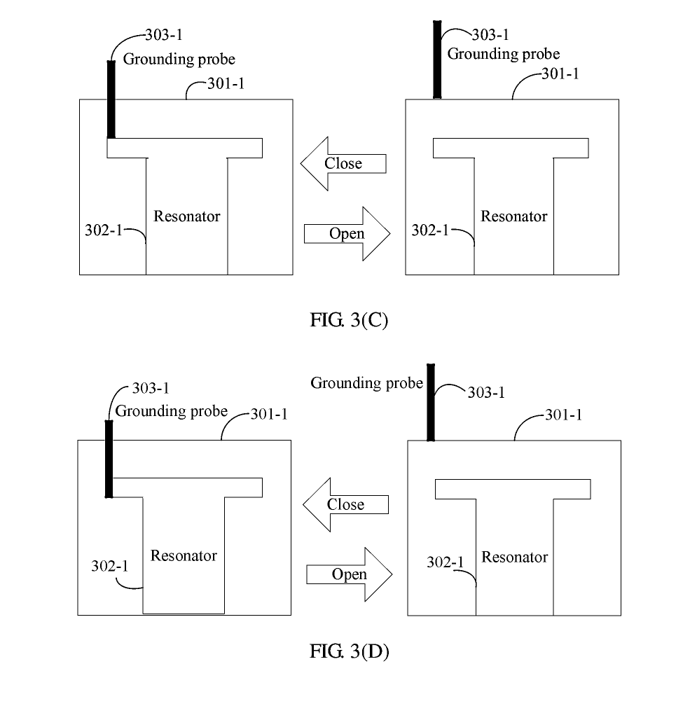

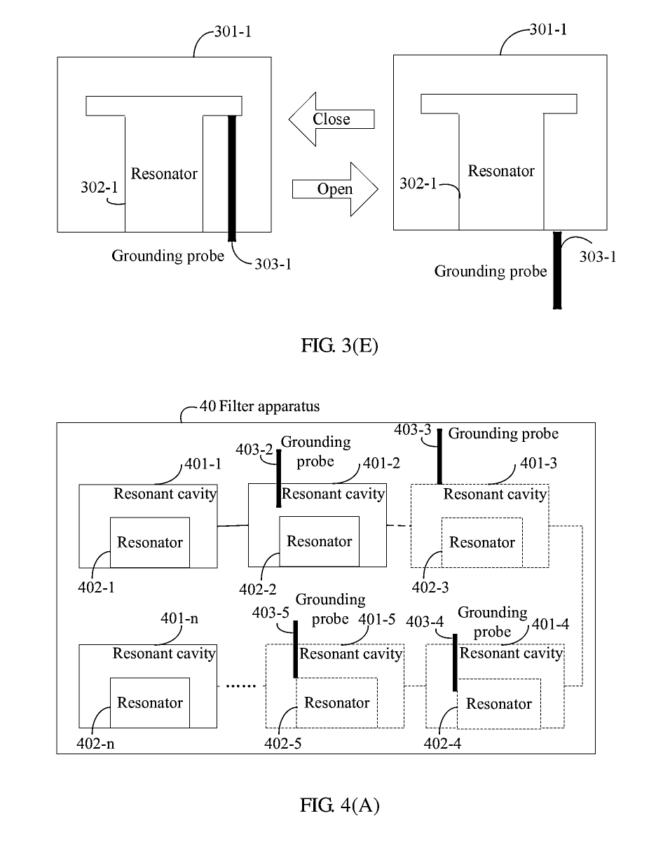

As shown in FIG. 3(A) to FIG. 3(E), a second embodiment of the present invention provides a filter apparatus 30, where the filter apparatus 30 is a further refinement of the filter apparatus 20 provided by the first embodiment of the present invention.

The filter apparatus 30 includes: at least one resonant cavity (for example, resonant cavities 301-1 to 301-n shown in FIG. 3(A), where n is the number of actually used resonant cavities), and each of the at least one resonant cavity includes one resonator, and the filter apparatus 30 further includes:
at least one grounding probe (for example, grounding probes 303-1 to 303-m shown in FIG. 3(A), where m is the number of actually used grounding probes), where the at least one grounding probe 303 is configured in the filter apparatus 30, the at least one grounding probe is a conductor connected to an electrical ground, and when any one of the at least one grounding probe moves into any one of the at least one resonant cavity to contact or approach a resonator, the filter apparatus 30 is closed; reversely, after the at least one grounding probe leaves the resonant cavity, and when a signal of a nominal band of the filter apparatus passes through the filter apparatus, and its output does not satisfy an index initially set by a system, the filter apparatus is opened.

In the second embodiment of the present invention, the at least one resonant cavity is resonant cavities 301-1 to 301-n shown in FIG. 3(A), where n is the number of actually used resonant cavities; the resonator in each of the at least one resonant cavity is resonators 302-1 to 302-n shown in FIG. 3(A), where n is the number of actually used resonant cavities; and the at least one grounding probe is grounding probes 303-1 to 303-m shown in FIG. 3(A), where m is the number of actually used grounding probes, and the number m of actually used grounding probes is not necessarily equal to the number n of actually used resonant cavities.

Further, as shown in FIG. 3(B), if any one (for example, a grounding probe 303-1 shown in FIG. 3) of the at least one grounding probe is of piezoelectric driving material, the filter apparatus 30 further includes:
at least one piezoelectric apparatus (for example, piezoelectric apparatuses 304-1 to 304-m shown in FIG. 3(B), where m is the number of actually used piezoelectric apparatuses), where one of the at least one piezoelectric apparatus is connected to one end of the grounding probe of the piezoelectric driving material. The piezoelectric apparatus produces a voltage, and drives the grounding probe to deform and move into the resonant cavity to contact or approach the resonator.

Further, any one of the at least one grounding probe may move into any one of the at least one resonant cavity to contact or approach the top of the resonator; or any one of the at least one grounding probe may move into any one of the at least one resonant cavity to contact or approach a side of the resonator; or any one of the at least one grounding probe may move into any one of the at least one resonant cavity to contact or approach the bottom of the resonator. As shown in FIG. 3(C), a grounding probe 303-1 moves into a resonant cavity 301-1 to contact or approach the top of a resonator 302-1, and the filter apparatus 30 is closed; and the grounding probe 303-1 leaves the resonant cavity 301-1, and the filter apparatus 30 is opened. As shown in FIG. 3(D), the grounding probe 303-1 moves into the resonant cavity 301-1 to contact or approach a side of the resonator 302-1, and the filter apparatus 30 is closed; and the grounding probe 303-1 leaves the resonant cavity 301-1, and the filter apparatus 30 is opened. As shown in FIG. 3(D), the grounding probe 303-1 moves into the resonant cavity 301-1 to contact or approach the bottom of the resonator 302-1, and the filter apparatus 30 is closed; and the grounding probe 303-1 leaves the resonant cavity 301-1, and the filter apparatus 30 is opened.

In the second embodiment of the present invention, a mutual connection form among multiple resonant cavities is a series connection, but the embodiments of the present invention are not limited thereto, and the connection may be a series connection, and may also be a parallel connection, and may also be a connection in a manner of combining the series connection and parallel connection.

Further, that any one of the at least one grounding probe moves into any one of the at least one resonant cavity to contact or approach the resonator is specifically that any one of the at least one grounding probe moves into any one of the at least one resonant cavity to contact or approach a resonant pole of the resonator.

In application of the technical solution provided by the second embodiment of the present invention, a form of disturbing the resonant cavity is not limited; the grounding probe connected to the electrical ground contacts or approaches the resonator to short-circuit or disturb the resonant cavity that includes the resonator, so as to achieve the effect of closing the filter apparatus. When the filter apparatus is used in combination with multiple other filter apparatuses, and when the filter apparatus is closed, spurious signals of the other filter apparatuses are not propagated to an antenna port through the filter apparatus.

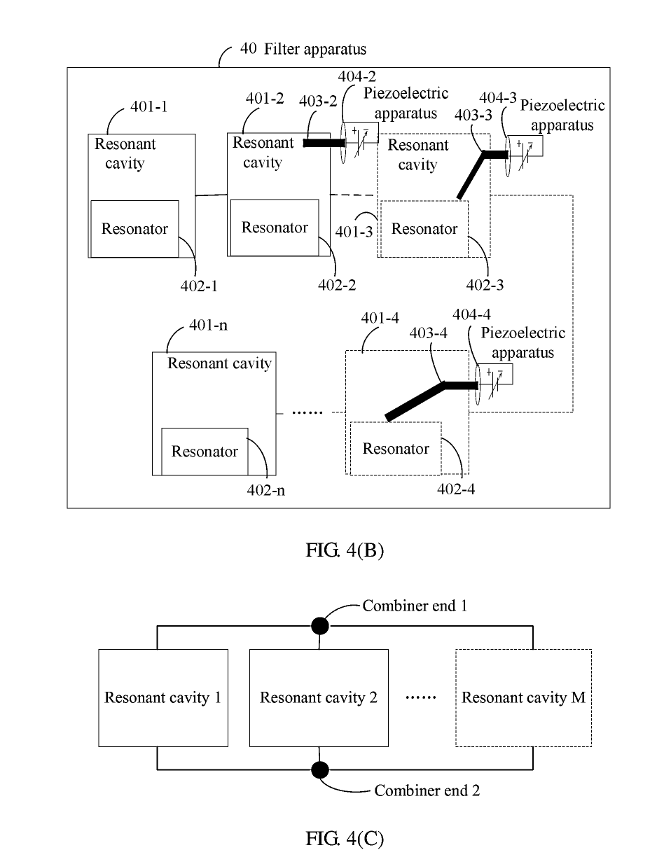

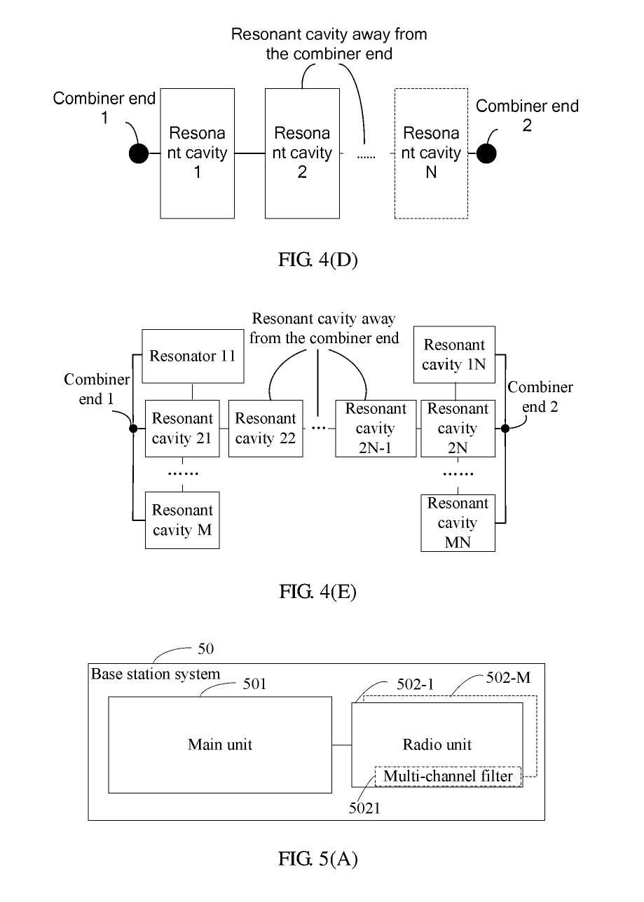

As shown in FIG. 4(A) and FIG. 4(B), a third embodiment of the present invention provides a filter apparatus 40, where the filter apparatus 40 is a further refinement of the filter apparatus 20 provided by the first embodiment of the present invention and the filter apparatus 30 provided by the second embodiment of the present invention.

A difference between the third embodiment and the first and second embodiments of the present invention lies in that any one of at least one resonant cavity, into which any one of at least one grounding probe moves, is a resonant cavity far away from a combiner end (for example, a resonant cavity 401-1 shown in FIG. 4(A)).

In the third embodiment of the present invention, the combiner end is a combiner position of two or more resonant cavity channels, where in the combiner position, an apparatus (for example, a combiner) having a combiner function may be used to connect the two or more resonant cavity channels. FIG. 4(C) shows a parallel connection of M resonant cavities (M is the number of actually used resonant cavities), where the M resonant cavities are all connected to combiner end 1 and combiner end 2. In this case, no resonant cavity far away from the combiner end exists. FIG. 4(D) shows series connections of N resonant cavities (N is the number of actually used resonant cavities), where only resonant cavity 1 and resonant cavity N of the N resonant cavities are connected to combiner end 1 and combiner end 2 respectively. Resonant cavity 2 to resonant cavity N−1 are all resonant cavities far away from the combiner ends; when N is an odd number, resonant cavity (N+1)/2 is a resonant cavity farthest away from combiner end 1 or combiner end 2; when N is an even number, resonant cavity N/2 and resonant cavity N/2+1 are resonant cavities farthest away from combiner end 1 or combiner end 2. FIG. 4(E) shows a mix connection form of a series connection and parallel connection of multiple resonant cavities, and in essence, it may be split into forms in FIG. 4(C) and FIG. 4(D); resonant cavity 22 to resonant cavity 2N−1 are resonant cavities far away from the combiner ends. Combiner ends referred to in the following all represent the meaning and are not further described.

When multiple filter apparatuses provided by the first embodiment of the present invention and the second embodiment of the present invention are connected and used in combination, a certain match condition also needs to be satisfied between two adjacent filter apparatuses. If the grounding probe moves into a resonant cavity directly connected to a combiner end (for example, a resonant cavity 401-1 shown in FIG. 4(A) and a resonant cavity 401-1 shown in FIG. 4(B)) and contacts or approaches the resonator in the resonant cavity, as described in the first embodiment and second embodiment of the present invention, the filter apparatus is closed; however, this manner damages a match condition that two adjacent filter apparatuses or their two corresponding frequency channels should satisfy when multiple filter apparatuses are connected and used together, which possibly causes that another filter apparatus adjacent to the filter apparatus cannot work normally. Therefore, when the grounding probe is used to short-circuit or disturb the resonant cavity, the technical solution provided by the third embodiment of the present invention may cause the filter apparatus that contains the resonant cavity to be closed, and short-circuit or disturb a resonant cavity far away from the combiner end, and may also reduce an impact on another filter apparatus connected to the filter apparatus. This effect is more obvious as a resonant cavity farther away from the combiner end is short-circuited or disturbed. When this effect satisfies a certain system performance index, it is deemed that the impact received by another filter apparatus connected to the filter apparatus is ignorable.

In application of the technical solution provided by the third embodiment of the present invention, the filter apparatus may be closed, and when multiple filter apparatuses are used in combination, an impact which is on the other filter apparatus and is caused by closing one of two adjacent filter apparatuses may be reduced.

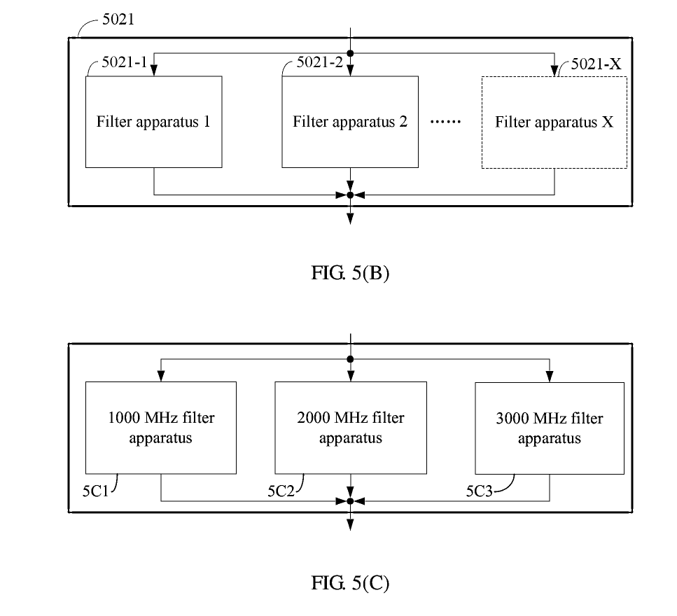

As shown in FIG. 5(A) and FIG. 5(B), a fourth embodiment of the present invention provides a base station system 50, including: a main unit 501 and at least one radio frequency unit (for example, a radio frequency unit 502-1 to a radio frequency unit 502-M, where M is the number of actually used radio frequency units), where the main unit 501 and the at least one radio frequency unit are connected through an optical fiber, and any one (for example, a radio frequency unit 502-1) of the at least one radio frequency unit further includes: a multi-channel filter 5021, where the multi-channel filter 5021 includes at least two filter apparatuses (for example, filter apparatuses 5021-1 to 5021-X shown in FIG. 5(B), where X is the number of actually used filter apparatuses) provided by the first embodiment or second embodiment or third embodiment of the present invention, and the at least two filter apparatuses are connected in parallel, that is, the at least two filter apparatuses are connected to a same input port or a same output port.

In the fourth embodiment of the present invention, that the base station system closes any combination of at least two filter apparatuses in the multi-channel filter may implement frequency channel switching of the base station system. For example, when the multi-channel filter contains only two filter apparatuses, the multi-channel filter may be a dual-channel filter 1022 shown in FIG. 1, where that the dual-channel filter closes either filter apparatus can implement switching from a dual-frequency working mode to a single-frequency working mode; and that the dual-channel filter opens either closed filter apparatus can implement switching from the single-frequency working mode to the dual-frequency working mode. Likewise, when the multi-channel filter is made up of three or more filter apparatuses, switching from a multi-frequency working mode to the single-frequency working mode or from one multi-frequency working mode to another multi-frequency working mode may be implemented. For example, as shown in FIG. 5(C), a multi-channel filter is made up of a filter apparatus 5C1 with a center frequency of 1000 MHz, a filter apparatus 5C2 with a center frequency of 2000 MHz, and a filter apparatus 5C3 with a center frequency of 3000 MHz; by closing or opening any combination of these filter apparatuses, switching from three frequency channels to one frequency channel, switching from three frequency channels to two frequency channels, or switching from two of the frequency channels to other two of the frequency channels, and so on may be implemented. For example, currently 5C1 and 5C2 work normally, but 5C3 is closed; in this case, 5C3 may be opened first, that is, a grounding probe in 5C3 is moved away from the resonator, and then 5C1 is closed, so as to implement a state that 5C2 and 5C3 work normally but 5C2 is closed.

In application of the technical solution provided by the present invention, the base station system closes any combination of at least two filter apparatuses in the multi-channel filter, and a spurious signal of another filter apparatus cannot pass a filter apparatus closed by the multi-channel filter, so that the frequency channel switching of the base station system is implemented.

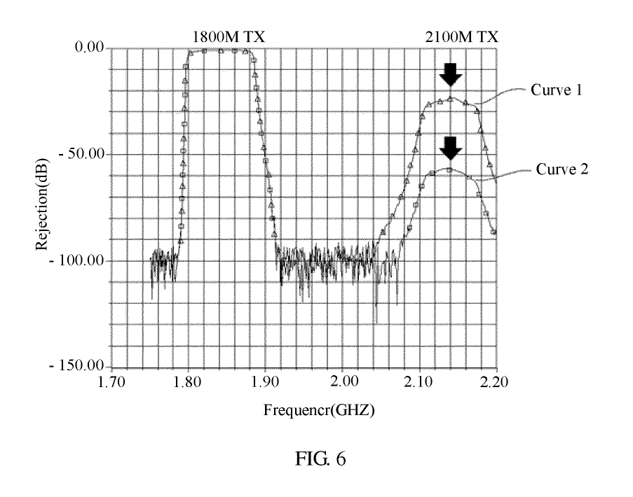

When the multi-channel filter of the radio frequency unit in the base station system described in the fourth embodiment of the present invention is made up of at least two filter apparatuses provided by the third embodiment of the present invention, for example, in a dual-channel filter, assuming that this two channels correspond to filter apparatuses with center frequencies of 1800 MHz and 2100 MHz respectively, the dual-channel filter needs to implement three states: that a 1800 MHz channel is on, and a 2100 MHz channel is off; that the 1800 MHz channel is off, and the 2100 MHz channel is on; and that the 1800 MHz channel is on, and the 2100 MHz channel is on. In application of the technical solution provided by the embodiment of the present invention, the grounding probe in the filter apparatus short-circuits one or more resonant cavities (the one or more resonant cavities are preferably resonant cavities far away from the combiner end) to achieve an effect of turning off the channel. As shown in FIG. 6, it is a diagram showing an effect that the dual-channel filter implements turning on of the 1800 MHz channel and turning off of the 2100 MHz channel, where the vertical axis represents signal rejection (unit: dB), the horizontal axis represents signal frequencies (unit GHz), and “1800TX” and “2100TX” represent two frequency channels with center frequencies 1800 MHz and 2100 MHz respectively. In FIG. 6, curve 1 shows an effect of short-circuiting a resonant cavity, and it can be seen that the 2100 MHz channel reaches signal rejection of about −20 dB; curve 2 shows an effect of short-circuiting two resonant cavities, and it can be seen that the 2100 MHz channel reaches signal rejection of about −50 dB. By short-circuiting a resonant cavity, certain attenuation may be produced for a signal, and the attenuation may be increased by increasing the number of short-circuited resonant cavities; when the attenuated signal can be ignored relative to a system index, it can be deemed that one channel of the multi-channel filter is turned off. It can also be seen from FIG. 6 that after a signal of the 2100 MHz channel is rejected, there is no impact on signal transmission of the 1800 MHz channel.

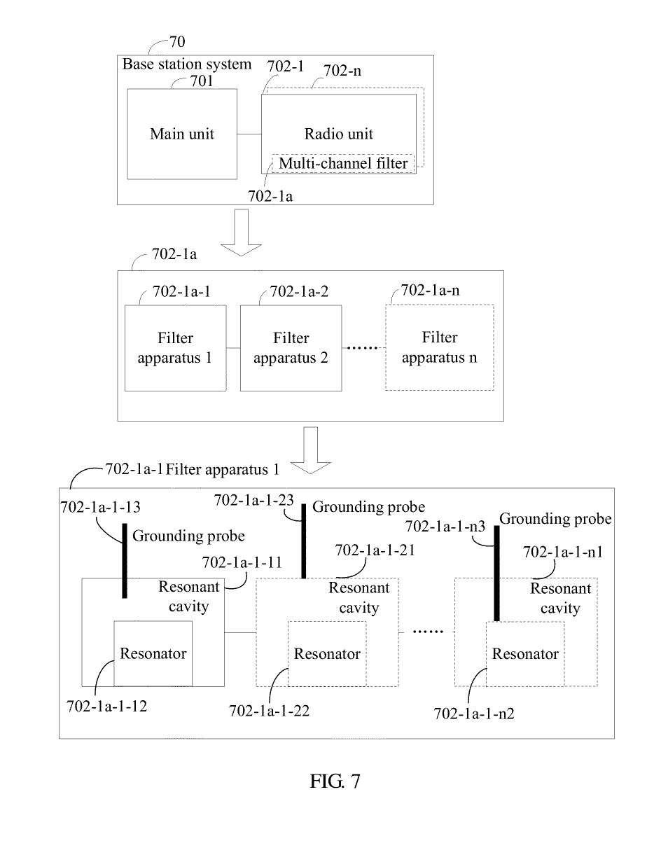

As shown in FIG. 7, a fifth embodiment of the present invention provides a method for frequency channel switching. A base station system 70 includes a main unit 701 and at least one radio frequency unit (for example, radio frequency units 702-1 to 702-n, where n is the number of actually used radio frequency units), where the main unit 701 and the at least one radio frequency unit are connected through an optical fiber.

In this method, one multi-channel filter 702-1a is integrated in any one of the at least one radio frequency unit, where the multi-channel filter 702-1a is made up of at least two filter apparatuses (for example, a filter apparatus 702-1a-1 and a filter apparatus 702-1a-2), where the at least two filter apparatuses are connected in parallel. The multi-channel filter 702-1a closes any combination of the at least two filter apparatuses to implement frequency channel switching of the base station system. Any one of the at least two filter apparatuses (for example, a filter apparatus 702-1a-1 in FIG. 7) includes at least one resonant cavity; each of the at least one resonant cavity (for example, a resonant cavity 702-1a-1-11) includes one resonator (for example, a resonator 702-1a-1-12); any one of the at least two filter apparatuses further includes at least one grounding probe (for example, a grounding probe 702-1a-1-13), where the at least one grounding probe is a conductor connected to an electrical ground, and when any one of the at least one grounding probe moves into any one of the at least one resonant cavity to contact or approach a resonator, the filter apparatus that contains the at least one resonant cavity is closed.

According to the technical solution provided by the embodiment of the present invention, in the radio frequency unit of the base station system, it is configured the multi-channel filter to close any combination of the at least two filter apparatuses, and a spurious signal of another filter apparatus cannot pass a filter apparatus closed by the multi-channel filter, so that frequency channel switching of the base station system is implemented.

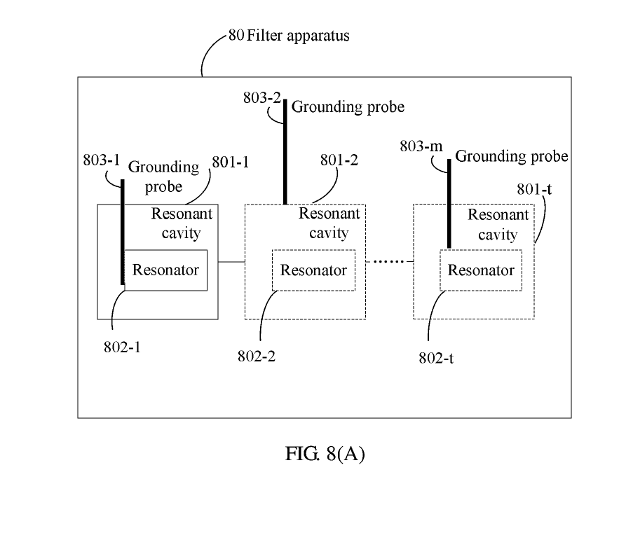

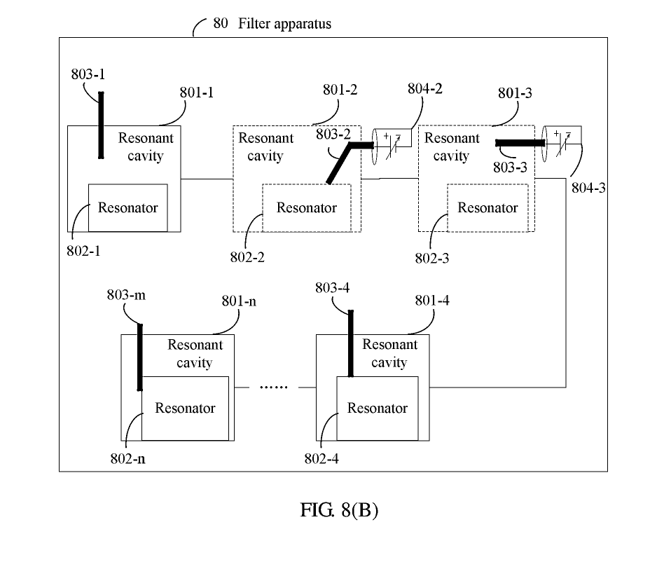

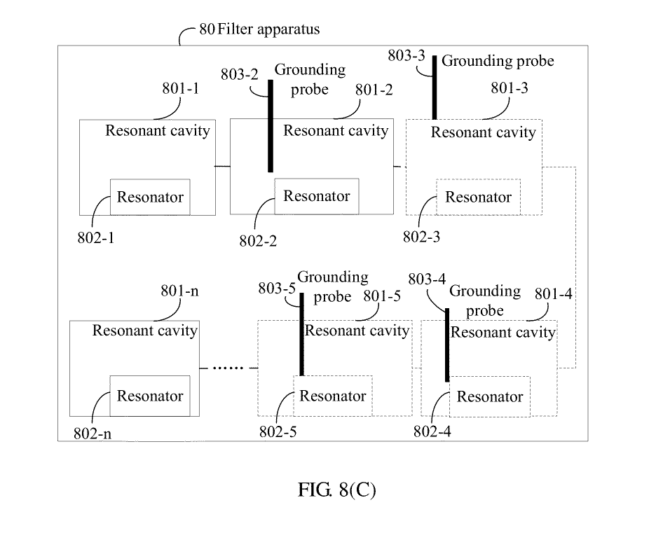

As shown in FIG. 8(A) and FIG. 8(B), a sixth embodiment of the present invention provides a method for frequency channel switching. The method is based on the method described in the fifth embodiment of the present invention, and is a further refinement of the filter apparatus in the method described in the fifth embodiment. A filter apparatus 80 includes at least one resonant cavity (for example, resonant cavities 801-1 to 801-t shown in FIG. 8(A), where t is the number of actually used resonant cavities), where each of the at least one resonant cavity includes one resonator.

In this method, at least one grounding probe (for example, grounding probes 803-1 to 803-m shown in FIG. 8(A), where m is the number of actually used grounding probes) is configured in the filter apparatus 80, where the at least one grounding probe is a conductor connected to an electrical ground, and when any one of the at least one grounding probe moves into any one of the at least one resonant cavity to contact or approach a resonator, the filter apparatus 70 is closed.

Further, if the at least one grounding probe (for example, a grounding probe 803-2 in

FIG. 8(B)) is of piezoelectric driving material, at least one piezoelectric apparatus (for example, 804-2 in FIG. 8(B)) is configured in the filter apparatus 80, where any one of the at least one piezoelectric apparatus is connected to any one of the at least one grounding probe. The piezoelectric apparatus may produce a voltage, and drive the grounding probe to deform and move into the resonant cavity to contact or approach the resonator.

Further, any one (for example, a grounding probe 803-4 shown in FIG. 8(A) or FIG. 8(B)) of the at least one grounding probe may move into any one (for example, a resonant cavity 801-4 shown in FIG. 8(A) or FIG. 8(B)) of the at least one resonant cavity to contact or approach the top of the resonator; or any one (for example, a grounding probe 803-m shown in FIG. 8(A) or FIG. 8(B)) of the at least one grounding probe may move into any one (for example, the resonant cavity 801-n shown in FIG. 8(A) or FIG. 8(B)) of the at least one resonant cavity to contact or approach a side of the resonator; or any one of the at least one grounding probe may also move into any one of the at least one resonant cavity to contact or approach the bottom of the resonator.

Further, that any one of the at least one grounding probe moves into any one of the at least one resonant cavity to contact or approach the resonator is specifically that any one of the at least one grounding probe moves into any one of the at least one resonant cavity to contact or approach a resonant pole of the resonator.

Further, as shown in FIG. 8(C), any one of the at least one resonant cavity into which any one of the at least one grounding probe moves is a resonant cavity far away from a combiner end.

In application of the technical solution provided by the sixth embodiment of the present invention, a form of disturbing the resonant cavity is not limited; a conductor in a form of a probe is used to make an electrical ground and a resonator, and the grounding probe connected to the electrical ground contacts or approaches the resonator to short-circuit or disturb at least one resonant cavity, so as to achieve an effect of closing the filter apparatus. In addition, when multiple filter apparatuses are used together, an impact which is on the other filter apparatus and is caused by closing one of two adjacent filter apparatuses may be reduced.

In some embodiments, detailed descriptions of known methods, interfaces, and device signaling technologies are provided, so that the present invention is not ambiguous due to unnecessary details. Those of ordinary skill in the art can understand that all or part of the steps in the methods of the foregoing embodiments can be implemented by a program instruction relevant hardware. The program may be stored in a computer readable storage medium, where the storage medium a read-only memory (Read-Only Memory, ROM), a random access memory (Random Access Memory, RAM), a magnetic disk, an optical disk or the like.

The above descriptions are merely exemplary embodiments of the present invention, and it should be noted that those skilled in the art can make various improvements and refinements without departing from the principle of the invention. Such modifications and refinements shall also fall within the protection scope of the present invention.

What is claimed is:

1. A filter apparatus, comprising at least one resonant cavity, wherein each of the at least one resonant cavity contains one resonator, and the filter apparatus further comprises:
at least one grounding probe, wherein the at least one grounding probe is configured in the filter apparatus, the at least one grounding probe is a conductor connected to an electrical ground, and when any one of the at least one grounding probe moves into any one of the at least one resonant cavity to contact or approach a resonator, the filter apparatus is closed.

2. The filter apparatus according to claim 1, wherein when any one of the at least one grounding probe is of piezoelectric driving material, the filter apparatus further comprises:
at least one piezoelectric apparatus, wherein one of the at least one piezoelectric apparatus is connected to one end of the grounding probe of the piezoelectric driving material.

3. The filter apparatus according to claim 1, wherein that any one of the at least one grounding probe moves into any one of the at least one resonant cavity to contact or approach the resonator specifically comprises:
moving, by any one of the at least one grounding probe, into any one of the at least one resonant cavity to contact or approach the top of the resonator; or
moving, by any one of the at least one grounding probe, into any one of the at least one resonant cavity to contact or approach a side of the resonator; or
moving, by any one of the at least one grounding probe, into any one of the at least one resonant cavity to contact or approach the bottom of the resonator.

4. The filter apparatus according to claims 1, wherein that any one of the at least one grounding probe contacts or approaches the resonator is: contacting or approaching a resonant pole of the resonator.

5. The filter apparatus according to claim 1, wherein when the number of the at least one resonant cavity is two or more, a connection manner among the at least one resonant cavity is a series connection, or a parallel connection, or a mix form of the series connection and parallel connection.

6. The filter apparatus according to claim 1, wherein any one of the at least one resonant cavity into which any one of the at least one grounding probe moves is a resonant cavity far away from a combiner end.

7. The filter apparatus according to claim 6, wherein the combiner end is an apparatus having a combiner function.

8. A base station system, comprising: a main unit and at least one radio frequency unit, wherein the main unit and the at least one radio frequency unit are connected through an optical fiber, and the radio frequency unit comprises: a multi-channel filter, wherein the multi-channel filter comprises at least two filter apparatuses according to claim 1 , and the at least two filter apparatuses are connected in parallel.

9. The base station system according to claim 8, wherein that the at least two filter apparatuses are connected in parallel specifically comprises:
connecting the at least two filter apparatuses in parallel through an apparatus having a combiner function.

10. A filter, comprising:
at least one resonant cavity, wherein each of the at least one resonant cavity includes a resonator; and
at least one grounding probe, wherein the at least one grounding probe is a conductor connected to an electrical ground, and when any one of the at least one grounding probe moves into any one of the at least one resonant cavity to contact or approach the resonator, the filter is closed.
